(19) United States
(12) Patent Application Publication
(10) Pub. No.: US 2023/0407038 A1
(43) Pub. Date: Dec. 21, 2023

(54) EXPANDABLE, THERMOPLASTIC POLYMER PARTICLES BASED ON STYRENE POLYMERS AND PROCESS FOR THE PREPARATION THEREOF

(71) Applicant: INEOS STYROLUTION GROUP GMBH, Frankfurt am Main (DE)

(72) Inventors: Bianca WILHELMUS, Hanau (DE); Yvonne VAN VEEN, Uithoorn (NL); Dominik DOERR, Ludwigshafen (DE); Sebastian GROESCHEL, Pegnitz (DE); Tobias STANDAU, Bayreuth (DE); Volker ALTSTAEDT, Hamburg (DE); Regino WEBER, Muenchberg (DE); Thomas NEUMEYER, Bayreuth (DE); Peter SCHREIER, Bischofsgruen (DE); Max LOEHNER, Mistelgau/Obernsees (DE)

(21) Appl. No.: 18/250,907

(22) PCT Filed: Oct. 28, 2021
(86) PCT No.: PCT/EP2021/080009

§ 371 Date: Apr. 27, 2023

(30) Foreign Application Priority Data
Oct. 30, 2020 (EP) 20204862.5

(51) Int. Cl. C08J 9/232; C08J 9/00; C08J 9/14; C08J 9/16

(52) U.S. Cl. CPC C08J 9/232; C08J 9/0066; C08J 9/141; C08J 9/16; C08J 2201/03; C08J 2355/02; C08J 2203/14; C08J 2201/034; C08J 2325/12

(57) ABSTRACT

The invention relates to expandable polymer particles based on styrene polymers, to a process for the preparation thereof and to the use of the expandable polymer particles in a molded foam part. The polymer particles contain A) 87 to 99 wt. % of one or more styrene polymers (A), in relation to the total weight of (A), (B) and (C); B) 1 to 10 wt. % of one or more foaming agents (B); C) 0 to 3 wt. % of one or more nucleators or nucleating agents C); and optionally further additives (Z) in amounts which do not impair the domain formation and the foam structure resulting therefrom.

The invention relates to expandable polymer particles based on styrenic polymers, to a process for the production thereof and to the use of the expandable polymer particles for molded foam parts.

Particle foams have been used for years in numerous applications, including insulation in construction, packagings and structural lightweight wall materials in the automotive sector. Particle foams usually consist of many foamed (expanded) polymer beads that are welded together. Compared to solid materials, particle foams typically offer the advantage of weight reduction coupled with good mechanical properties.

Particle foams composed of polyolefins, such as polyethylene, have been known for decades, see U.S. Pat. No. 6,028,121. CN-A 107501595 describes a process for producing particles from expanded polypropylene. One disadvantage of particle foams composed of polyolefins is that they need to be completely foamed already during production, since the blowing agent does not remain in the polymer material for prolonged periods. It is not possible to produce blowing agent-laden polyolefin particles that can still be expanded after a certain storage time. A temporal and spatial separation of production of the particles and processing (foaming) is not possible despite being desirable in practice. Only already foamed polyolefin particles can be produced and processed. The transport of such particles is more costly and complex than the transport of non-foamed products/particles.

It is therefore desirable to provide expandable polymer particles that can be stored over an extended period and optionally transported at low cost and complexity.

EP-A 2384355 (BASF) describes expandable, thermoplastic polymer particles containing a styrenic polymer and a polyolefin. Since the employed polymers are not miscible with one another it is necessary to employ a compatibilizer to adjust the morphology. The use of polyolefins and compatibilizers is necessary to achieve particle foams with high stiffness and good elasticity that are not achievable with a particle foam consisting only of polystyrene.

However, the use of polyolefins with a compatibilizer requires at least one additional process step, namely the production of a blend of at least three components; polystyrene, polyolefin and compatibilizer. In addition, suitable compatibilizers are often complex and the production of these components is costly. In addition, a material consisting of only one type of polymer which can be reintroduced into the corresponding material cycle is advantageous in terms of simplified recycling of the particle foams at the end of their service life.

U.S. Pat. No. 4,108,806 (Dow, 1978) describes a process for producing expanded and expandable polymer particles based on a polyolefin matrix, into which expandable microspheres are introduced. The microspheres consist of a thermoplastic shell and a core of a volatile liquid blowing agent which brings about an expansion of the polymer composition upon heating. This production method is costly and complex and forms a polymer mixture of two or more polymer types.

WO 2013/085742 (Dow) describes the provision of an extruded polymer foam produced using a blowing agent mixture of 74-78% by weight of 1,1,1,2-tetrafluoroethane, 13-16% by weight of CO 2 and 7-9% by weight of water but the provision of expandable polymer particles is not addressed.

U.S. Pat. No. 7,919,538 (Dow) describes a particle foam consisting of SAN and an additive that shields infrared radiation for the purpose of improved thermal insulation; expandable polymer particles are not sought.

U.S. Pat. No. 3,945,956 describes a process for producing expandable polymer particles in which a volatile liquid blowing agent is enclosed in a hollow sphere composed of styrene and acrylonitrile. The blowing agent is enclosed in a polymer particle but not homogeneously distributed in a polymer matrix. As a result, the expansion of such polymer particles results in a foam having inhomogeneously distributed cavities.

U.S. Pat. No. 5,480,599 describes a process for producing particle foams. The blowing agent is at least partially recoverable after expansion of the particles. However, the process provides only expanded polymer particles and not expandable particles. U.S. Pat. No. 5,049,328 describes a process for foam production without organic blowing agents. Only inert gases such as CO₂, nitrogen or air are used as blowing agents. The process is not suitable for providing expandable polymer particles storable for a certain period of time (for example days, weeks, months). Gases consisting of small molecules may in some cases escape from the polymer composition quickly.

There is a great need for a process for providing expandable polymer particles that may be stored for a certain period of time and can optionally be transported with minimal cost and complexity and moreover consist of a single polymer class to simplify recycling. There is moreover a need for expandable polymer particles in which the cavities are very largely homogeneously distributed after expansion and in which a fine-celled foam structure is present. Furthermore, molded parts having adequate mechanical properties shall be producible from the expandable polymer particles.

It is accordingly an object of the present invention to provide expandable, thermoplastic polymer particles having low blowing agent loss and high expansion capacity which (even after processing) can be recycled without great technical complexity and which can be processed into particle foams having high stiffness and good elasticity and also a process for production thereof.

It has surprisingly been found that this object is achieved by producing the expandable, thermoplastic polymer particles according to the invention.

The expandable, thermoplastic polymer particles contain or preferably consist of:
A) 87% to 99% by weight, preferably 91% to 97% by weight, based on the total weight of (A), (B) and (C), of one or more styrenic polymers (A), wherein at least one styrenic polymer (A) is not a styrene homopolymer;
B) 1% to 10% by weight, preferably 3% to 7% by weight, based on the total weight of (A), (B) and (C), of one or more blowing agents (B);
C) 0% to 3% by weight, preferably 0.1% to 2% by weight, based on the total weight of (A), (B) and (C), of one or more nucleators or nucleating agents (C); and optionally one or more further additives (Z) in an amount that does not impair domain formation and the foam structure resulting therefrom.

The expandable, thermoplastic polymer particles generally contain no further polymers in addition to the one or more styrenic polymers (A); wherein the styrenic polymers (A) are miscible with one another if the expandable, thermoplastic polymer particles contain two or more styrenic polymers (A); and wherein the expandable, thermoplastic polymer particles are thermoplastically recyclable.

In the present description the term “thermoplastically recyclable” is to be understood as meaning that the expandable, thermoplastic polymer particles are well suited (without great technical complexity) for recycling, for example in a mechanical recycling process. Styrenic polymers are considered well suited for recycling in particular if the styrenic polymer (A) consists of only one polymer class, or if the two or more styrenic polymers (A) consist of polymer classes that are readily miscible with one another, such as for example SAN, AMSAN, ABS and ASA.

In one embodiment the styrenic polymer (A) consists of only one polymer class such as SAN, AMSAN, ABS and ASA. In this embodiment the expandable polymer particles according to the invention are particularly readily recyclable, for example in mechanical recycling processes. In a further embodiment the styrenic polymer (A) consists of polymer classes which are miscible with one another. In this case too, good recyclability/suitability for recycling is ensured, for example in mechanical recycling processes. Good miscibility is apparent from the absence of two or more phases at the processing temperature (e.g. 200-260° C.).

It is preferable when the blowing agent (B) in the expandable, thermoplastic polymer particles is homogeneously distributed in a polymer matrix of the one or more of the styrenic polymers (A).

The expandable thermoplastic polymer particles contain 87% to 99% by weight, preferably 91% to 97% by weight, particularly preferably 93.5% to 97% by weight, based on the total weight of (A), (B) and (C), of one or more styrenic polymers (A) selected for example from the group consisting of styrene-acrylonitrile copolymers (SAN), acrylonitrile-butadiene-styrene copolymers (ABS), acrylate-styrene-acrylonitrile copolymers (ASA), methyl methacrylate-acrylonitrile-butadiene-styrene copolymers (MABS), methyl methacrylate-butadiene-styrene copolymers (MBS), α(alpha)-methylstyrene-acrylonitrile copolymers (AMSAN), styrene-methyl methacrylate copolymers (SMMA), amorphous polystyrene (PS) and impact-modified polystyrene (HIPS). The styrenic polymer (A) is preferably selected from the group consisting of styrene-acrylonitrile copolymers (SAN), acrylonitrile-butadiene-styrene copolymers (ABS) or acrylonitrile-styrene-acrylate copolymers (ASA).

Particular preference is given to styrene-acrylonitrile copolymers, acrylonitrile-butadiene-styrene copolymers or acrylonitrile-styrene-acrylate copolymers having a melt volume rate MVR (220° C./10 kg) according to ISO 1133 in the range from 1 to 12 cm³/10 min, preferably in the range from 1 to 10 cm³/10 min. In a preferred embodiment the styrenic polymer (A) contains no styrene homopolymer.

In a further preferred embodiment the expandable, thermoplastic polymer particles contain no polymers other than the styrenic polymer (A) which preferably contains no styrene homopolymer. Component (A) consists for example of SAN, ABS, ASA and/or mixtures containing at least two of these polymers. In the case of ABS as component (A) it is preferable to also employ at least one component (C).

As blowing agent (component (B)) the expandable, thermoplastic polymer particles contain 1% to 10% by weight, preferably 3% to 7% by weight, particularly preferably 4% to 6% by weight, based on the total weight of (A), (B) and (C), of one or more physical blowing agents, such as CO₂, aliphatic C₃- to C₈-hydrocarbons, alcohols, ketones, ethers or halogenated hydrocarbons, preferably CO 2 or alternatively isobutane, n-butane, isopentane, n-pentane (b.p. 36° C.), cyclopentane or mixtures thereof.

As component (C) the expandable, thermoplastic polymer particles contain 0% to 3% by weight, preferably 0% to 2% by weight, often 0.1% to 2% by weight, particularly preferably 0.1% to 0.8% by weight, based on the total weight of (A), (B) and (C), of one or more nucleators or nucleating agents, for example talc, aluminum oxide or silica.

The expandable, thermoplastic polymer particles may moreover be admixed with further additives (Z) such as for example plasticizers, flame retardants, soluble and insoluble inorganic and/or organic dyes and pigments, fillers, co-blowing agents or other additives in amounts that do not impair domain formation and the foam structure resulting therefrom (for example in the range from 0.1% to 5% by weight, in the range from 0.1% to 2% by weight, preferably in the range from 0.1% to 0.9% by weight, based on the total composition).

Additives that may be present in the expandable, thermoplastic polymer particles include customary plastics additives and auxiliaries. By way of example, an additive or an auxiliary may be selected from the group consisting of antioxidants, UV stabilizers, peroxide destroyers, antistats, lubricants, mold-release agents, flame retardants, fillers or reinforcers (glass fibers, carbon fibers, etc.), colorants and combinations of two or more of these.

Examples of oxidation retarders and heat stabilizers include halides of metals of group I of the periodic table, for example sodium, potassium and/or lithium halides, optionally in conjunction with copper(I) halides, for example chlorides, bromides, iodides, sterically hindered phenols, hydroquinones, substituted representatives of these groups and mixtures thereof in concentrations of up to 1% by weight based on the total weight of the expandable, thermoplastic polymer particles.

Suitable UV stabilizers which are generally present in amounts of up to 2% by weight, often 0.1-1.5% by weight, based on the total weight of the expandable, thermoplastic polymer particles include various substituted resorcinols, salicylates, benzotriazoles and benzophenones.

It is also possible for organic dyes such as nigrosin, pigments such as titanium dioxide, phthalocyanines, ultramarine blue and carbon black to be present as colorants in the thermoplastic polymer particles and also fibrous and pulverulent fillers and reinforcing agents. Examples of the latter are carbon fibers, glass fibers, amorphous silica, calcium silicate (wollastonite), aluminum silicate, magnesium carbonate, kaolin, chalk, powdered quartz, mica and feldspar.

Lubricants and demolding agents which may generally be employed in amounts of up to 1% by weight, often 0.1-0.8% by weight, based on the total weight of the expandable, thermoplastic polymer particles may include for example long-chain fatty acids such as stearic acid or behenic acid, their salts (e.g. Ca stearate or Zn stearate) or esters (e.g. stearyl stearate or pentaerythritol tetrastearate) and also amide derivatives (e.g. ethylenebisstearylamide).

Mineral-based antiblocking agents may moreover be present in amounts of up to 0.1% by weight based on the total weight of the expandable, thermoplastic polymer particles. Examples include amorphous or crystalline silica, calcium carbonate or aluminum silicate.

Also possibly present as a processing aid are, for example, mineral oil, preferably medicinal white oil, in amounts of up to 5% by weight, preferably up to 2% by weight, in particular 0.1% to 2% by weight, based on the total weight of the expandable, thermoplastic polymer particles.

Examples of plasticizers include dioctyl phthalate, dibenzyl phthalate, butyl benzyl phthalate, hydrocarbon oils, N-(n-butyl)benzenesulfonamide and o- and p-tolylethylsulfonamide.

Any of the non-halogenated flame retardants known for the respective thermoplastics may moreover be present, in particular those based on phosphorus compounds.

In one embodiment the expandable, thermoplastic polymer particles consist of the styrenic polymer (A) and the blowing agent (B). In one embodiment the expandable, thermoplastic polymer particles consist of the styrenic polymer (A), the blowing agent (B) and the nucleator or nucleating agent (C). In a further embodiment the expandable, thermoplastic polymer particles consist of the styrenic polymer (A), the blowing agent (B), the nucleator or nucleating agent (C) and further additives (Z) in amounts that do not impair domain formation and the foam structure resulting therefrom.

If the styrenic polymer (A) is an acrylonitrile-butadiene-styrene copolymer (ABS) a nucleator or nucleating agent (C) is advantageously present in the expandable, thermoplastic polymer particles.

The invention provides a process for producing expandable, thermoplastic polymer particles, comprising the steps of:
a) admixing a styrenic polymer (A) with a blowing agent (B) and optionally a nucleator or nucleating agent (C) and optionally additives in amounts that do not impair domain formation and the foam structure resulting therefrom to form a polymer mixture (I),
b) pre-expanding the polymer mixture (I).

In one embodiment only the styrenic polymer (A) and the blowing agent (B) are employed as starting materials in the process. In a further embodiment only the styrenic polymer (A), the blowing agent (B) and the nucleator or the nucleating agent (C) are employed in the process. In a further embodiment only the styrenic polymer (A), the blowing agent (B), the nucleator or the nucleating agent (C) and further additives (Z) in amounts that do not impair domain formation and the foam structure resulting therefrom are employed in the process.

It is preferable when at least step b), particularly preferably steps a) and b), is/are carried out at a pressure in excess of atmospheric pressure.

In one embodiment of the invention process steps a) and b) are carried out in an extruder with subsequent underwater granulation at a pressure in the range from 1.5 to 11 bar.

In a further embodiment process steps a) and b) are carried out in an autoclave. The granulated styrenic polymer (A), optionally admixed with a nucleating agent (C) and with further additives, is impregnated with the blowing agent (B) under pressure to afford expandable, thermoplastic polymer particles. These may subsequently be isolated or obtained directly by decompression as pre-foamed foam particles.

In a further embodiment the styrenic polymer (A) is synthesized in a suspension and treated with a physical blowing agent.

Particular preference is given to a continuous process in which in process step a) a thermoplastic styrenic polymer (A), for example SAN, ABS or ASA, optionally mixed with the nucleating agent (C) and optionally the further additives, is melted in a twin-screw extruder and impregnated with the blowing agent (B). The blowing agent-laden melt may then be extruded through an appropriate die to afford foam sheets, strands or particles and cut in process step b). In a preferred embodiment extrusion is through a microperforated plate with one or generally two or more holes having a hole diameter of 0.1 to 2.4 mm, preferably 0.2 to 1.2 mm, particularly preferably 0.5 to 0.8 mm, to form particles. In a preferred embodiment the melt exiting the microperforated plate is passed into a water stream where the melt is cut into individual particles by a suitable apparatus. Adjustment of suitable counterpressure and a suitable temperature in the water stream of this so-called underwater granulation allows suitable production of expandable polymer particles.

The expandable, thermoplastic polymer particles according to the invention preferably have an average particle diameter in the range from 0.1 to 3 mm, preferably from 0.3 to 2 mm, particularly preferably from 0.5 to 1 mm. Expandable polymer particles having a narrow particle size distribution and an average particle diameter in the recited range result in better filling of the mold upon welding of the polymer particles to afford a molded part. They allow for more delicate molded part design and a better molded part surface.

In a further preferred embodiment the expandable, thermoplastic polymer particles are pre-foamed. The expandable polymer particles obtained are preferably foamed to an average diameter in the range from 0.2 to 10 mm.

The specific density of the expanded polymer particles is preferably in the range from 10 to 250 g/L, particularly preferably 20 to 200 g/L, particularly preferably 25 to 150 g/L and particularly preferably 30-100 g/L.

The expandable, thermoplastic polymer particles according to the invention may be filled into a mold which is then closed and has hot air or steam passed through it for heating. This causes the polymer particles to expand further, ideally until complete filling of the cavity, in order thus to form molded foam articles. The processing pressure selected is low enough to ensure that the domain structure in the cell membranes is retained. The pressure is typically in the range from 0.5 to 1.0 bar.

The invention accordingly provides for the use of expandable, thermoplastic polymer particles as described above in a molded foam body formed by welding the expandable polymer particles using hot air or steam. The molded part preferably has a specific density of less than 250 g/L, preferably less than 150 g/L. The invention also provides foams/molded articles obtained from the expandable, thermoplastic polymer particles.

The invention is more particularly illustrated by the following examples and claims.

In a co-rotating twin-screw extruder (type ZK25P, Collin GmbH) having a screw diameter of 30 mm and a length-to-diameter ratio of 42, the polymers (A) with the blowing agent (B) and optionally the nucleating agent (C) were melted at 200-240° C. melted and thus mixed to homogeneity.

The resulting polymer mixture (I) was subsequently cooled in a single-screw extruder (Typ E 45 M, Collin GmbH) having a screw diameter of 45 mm and a length-to-diameter ratio of 30 and the melt was extruded through a heated perforated plate. The polymer strand was cut by underwater granulation to obtain a blowing agent-laden minigranulate having a narrow particle size distribution.

The blowing agent-laden minigranulate was then prefoamed in an X-Line 3 prefoamer (Kurtz GmbH). The pre-foamed polymer particles were welded in a TVZ 162/100 PP molding machine (manufacturer Teubert Maschinenbau GmbH) at about 120-125° C. to produce test specimens for measurement of the thermal and mechanical properties.

The density of the prefoamed particles was determined in accordance with ISO 1183 using an AG245 density balance (Mettler Toledo).

Thermal characterization of the test specimens was carried out according to DIN EN 12667 with an HMF Lambda Small (Netzsch) heat flow meter using test specimens having dimensions of 200×200×20 mm and a temperature gradient of 20 K.

Mechanical characterization of the test specimens was carried out according to ISO 1209 using a 3-point bending test with a 1485 universal testing machine (Zwick Roell) on test specimens having dimensions of 120×25×20 mm with a pressure of 0.5 N and a test speed of 10 mm/min.

The results are shown in Tables 1 and 2 which follow.

It is apparent that test specimens consisting of the inventive compositions (experiments 1 to 3) have better mechanical properties than the test specimens composed of the noninventive composition (comparative experiment 4).

TABLE 1
Materials employed

| Components | Description |
|---|---|
| A1 | SAN (Luran ® 25100, INEOS Styrolution, DE) |
| A2 | ABS (Terluran ® HI-10, INEOS Styrolution) |
| A3 | PS (168N, INEOS Styrolution) (comparative material) |
| B | n-Pentane |
| C | Talc (Finntalc M30, Elementis, England) |

Instead of the commercially available SAN and ABS copolymer products mentioned it is also possible to employ further styrenic copolymers such as ASA or AMSAM. Further additives (Z) may also be used.

TABLE 2
Comparison of performed experiments

| | Experiment | Experiment | Experiment | Comparison |
|---|---|---|---|---|
| | 1 | 2 | 3 | 4 |
| Component | 93 | | | |
| (A1) | | | | |
| [% by wt.] | | | | |
| Component | | 92.6 | 92.2 | |
| (A2) | | | | |
| [% by wt.] | | | | |
| Component | | | | 93 |
| (A3) | | | | |
| [% by wt.] | | | | |
| Component | 7 | 7 | 7 | 7 |
| (B) | | | | |
| [% by wt.] | | | | |
| Component | | 0.4 | 0.8 | |
| (C) | | | | |
| [% by wt.] | | | | |
| Foam | 65 | 70 | 55 | 30 |
| density of | | | | |
| pre-foamed | | | | |
| particles | | | | |
| [g/L] | | | | |
| Thermal | 0.02959 | 0.03285 | 0.03309 | 0.02925 |
| conductivity | | | | |
| [W/m K] | | | | |
| Compressive | 470 | 328 | 190 | 196 |
| strength at | | | | |
| 10% [kPa] | | | | |
| Flexural | 45.7 | 23.6 | 14.3 | 12.9 |
| modulus | | | | |
| [MPa] | | | | |

The inventive compositions (experiments 1 to 3) are readily storable and in test specimens result in a better flexural modulus than the articles consisting of the noninventive composition (comparison 4).

Analogous results are also achievable with other blowing agents such as for example isobutane, n-butane, isopentane and cyclopentane.

The obtained polymer products/the molded articles consisting of SAN or ABS are recyclable without great cost and complexity, for example by recovery of styrene, as a result of which they are also of interest for ecological reasons.

1-15. (canceled)

16. Expandable, thermoplastic polymer particles containing:
A) 87% to 99% by weight, based on the total weight of (A), (B), and (C), of one or more styrenic polymers (A), wherein at least one of the one or more styrenic polymers (A) is not a styrene homopolymer;
B) 1% to 10% by weight, based on the total weight of (A), (B), and (C), of one or more blowing agents (B);
C) 0% to 3% by weight, based on the total weight of (A), (B), and (C), of one or more nucleators or nucleating agents (C); and
optionally one or more further additives (Z) in an amount that does not impair domain formation and the foam structure resulting therefrom;
wherein the expandable, thermoplastic polymer particles contain no further polymers in addition to the one or more styrenic polymers (A);
wherein the one or more styrenic polymers (A) are miscible with one another if the expandable, thermoplastic polymer particles contain two or more styrenic polymers (A); and
wherein the expandable, thermoplastic polymer particles are thermoplastically recyclable.

17. The expandable, thermoplastic polymer particles of claim 16, containing:
A) 91% to 97% by weight, based on the total weight of (A), (B), and (C), of the one or more styrenic polymers (A);
B) 3% to 7% by weight, based on the total weight of (A), (B), and (C), of the one or more blowing agents (B); and
C) 0.1% to 2% by weight, based on the total weight of (A), (B), and (C), of the one or more nucleators or nucleating agents (C).

18. The expandable, thermoplastic polymer particles of claim 16, wherein the one or more styrenic polymers (A) are at least one polymer selected from the group consisting of styrene-acrylonitrile copolymers (SAN), acrylonitrile-butadiene-styrene copolymers (ABS), acrylate-styrene-acrylonitrile copolymers (ASA), methyl methacrylate-acrylonitrile-butadiene-styrene copolymers (MABS), methyl methacrylate-butadiene-styrene copolymers (MBS), α(alpha)-methylstyrene-acrylonitrile copolymers (AMSAN), styrene-methyl methacrylate copolymers (SMMA), amorphous polystyrene (PS), and impact-modified polystyrene (HIPS).

19. The expandable, thermoplastic polymer particles of claim 16, wherein the one or more styrenic polymers (A) are at least one polymer selected from the group consisting of styrene-acrylonitrile copolymers (SAN), acrylonitrile-butadiene-styrene copolymers (ABS), and acrylate-styrene-acrylonitrile copolymers (ASA).

20. The expandable, thermoplastic polymer particles of claim 16, wherein the one or more styrenic polymers (A) are at least one styrenic polymer having a volume melt flow index measured according to ISO 1133 at 220° C. and under a load of 10 kg in the range from 1 to 12 cm³/10 min.

21. The expandable, thermoplastic polymer particles of claim 20, wherein the one or more styrenic polymers (A) are at least one styrenic polymer having a volume melt flow index measured according to ISO 1133 at 220° C. and under a load of 10 kg in the range from 1 to 10 cm³/10 min.

22. The expandable, thermoplastic polymer particles of claim 16, wherein the one or more blowing agents (B) are at least one blowing agent selected from the group consisting of CO₂, aliphatic C₃- to C₈-hydrocarbons, alcohols, ketones, ethers, and halogenated hydrocarbons.

23. The expandable, thermoplastic polymer particles of claim 22, wherein the one or more blowing agents (B) are at least one blowing agent selected from the group consisting of CO₂, isobutane, n-butane, isopentane, n-pentane, and cyclopentane.

24. The expandable, thermoplastic polymer particles of claim 16, wherein the one or more nucleators or nucleating agents (C) are at least one nucleating agent selected from the group consisting of talc, aluminum oxide, and silicon dioxide.

25. The expandable, thermoplastic polymer particles of claim 16, wherein the average particle diameter of the expandable, thermoplastic polymer particles in the non-prefoamed state is in the range from 0.1 to 3 mm.

26. The expandable, thermoplastic polymer particles of claim 16, wherein the polymer particles are prefoamed to an average diameter of 0.2 to 10 mm.

27. The expandable, thermoplastic polymer particles of claim 16, wherein the one or more blowing agents (B) are distributed homogeneously in a polymer matrix consisting of the one or more styrenic polymers (A).

28. A process for producing the expandable, thermoplastic polymer particles of claim 16, comprising the steps of:
a) admixing the one or more styrenic polymers (A) with the one or more blowing agents (B) and optionally the one or more nucleators or nucleating agents (C) and optionally the one or more additives (Z) in amounts that do not impair domain formation and the foam structure resulting therefrom to form a polymer mixture (I), and
b) pre-expanding the polymer mixture (I).

29. The process of claim 28, wherein at least step b) is carried out at a pressure in excess of atmospheric pressure.

30. The process of claim 28, wherein steps a) and b) are carried out at a pressure in excess of atmospheric pressure.

31. The process of claim 28, wherein process steps a) and b) are carried out in an extruder with subsequent underwater granulation at a pressure in the range from 1.5 to 11 bar.

32. The process of claim 28, wherein process steps a) and b) are carried out in an autoclave.

33. The process of claim 28, wherein process steps a) and b) are carried out in a suspension.

34. A molded part formed by welding the expanded, thermoplastic polymer particles of claim 16 using hot air or steam.

35. The molded part of claim 34, wherein the molded part has a specific density of less than 250 g/L.
